(19) United States
(12) Patent Application Publication
(10) Pub. No.: US 2010/0244595 A1
(43) Pub. Date: Sep. 30, 2010

(54) HEAT TRANSFER THROUGH ELECTRICAL SUBMERSIBLE PUMP MOTOR

(75) Inventor: Ketankuman K. Sheth, Tulsa, OK (US)

Correspondence Address: Bracewell & Giuliani LLP, P.O. Box 61389, Houston, TX, 77208-1389, US

(73) Assignee: Baker Hughes Inc., Houston, TX (US)

(21) Appl. No.: 12/751,532

(22) Filed: Mar. 31, 2010

Related U.S. Application Data
(60) Provisional application No. 61/165,339, filed on Mar. 31, 2009.

(51) Int. Cl. H02K 9/19

(52) U.S. Cl. 310/54

(57) ABSTRACT

The motor of an electrical submersible pump generates a significant amount of heat that can be removed by transferring it to the well production fluid. Grooves in the stator and motor housing facilitate more rapid heat transfer from the rotor and stator, through the motor lubricant, to the motor housing. Increased heat transfer to the motor housing facilitates increased heat transfer to the production fluid on the outside of the motor housing.

### CROSS-REFERENCE TO RELATED APPLICATIONS

This application claims priority to provisional application 61/165,339, filed Mar. 31, 2009.

### FIELD OF THE INVENTION

This invention relates in general to well pumps, and in particular to an electrical submersible pump motor using internal oil circulation to increase heat transfer.

### BACKGROUND

Electrical submersible pumps (“ESP”) can be used to pump fluid from a wellbore towards the surface of the earth. The ESP is inserted inside the wellbore, generally at great depths below the surface of the earth. The ESP includes a pump assembly, a motor, and a seal section between the pump and the motor. The motor includes a rotor that rotates within a stator. The rotor rotates on bearings which are connected to the stator. The bearings can generate a significant amount of heat that must be removed. Heat may also be generated by other heat sources, such as, for example, electrical resistance in the windings of the stator, rotor, and in the laminations of the motor. Failure to remove the heat can significantly shorten the life of the motor. To remove the heat, it is desirable to move the heat from the rotor and stator to the motor housing. The heat is then conducted through the motor housing to wellbore fluid located outside of the motor housing. There is a problem, however, in transferring the heat from the stator to the housing.

In a typical motor, there is a slight gap between the stator and the motor housing. The gap is necessary to be able to install and remove the stator from the housing. Unfortunately, the gap is generally filled with air, which is a poor heat conductor.

It is desirable to efficiently transfer heat from the stator to the motor housing.

### SUMMARY OF THE INVENTION

In this invention, internal grooves are used to facilitate lubricant flow between the stator and the motor housing in an electrical submersible pump (“ESP”) motor. The lubricant flow between the stator and the housing increases the rate of heat transfer from the stator to the housing, and therefore increases the rate of heat transfer from the housing to production fluid in contact with the exterior of the housing.

In some embodiments, grooves are formed on the interior of the motor housing. The grooves may extend longitudinally past each end of the stator, from an oil reservoir at one end of the housing to an oil reservoir at the other end of the housing. In various embodiments, the grooves may be longitudinal, circumferential, or helical. Furthermore, a plurality of groove types may be used in a single embodiment. In some embodiments, grooves on the interior of the housing create a corresponding ridge on the exterior of the housing.

In some embodiments, grooves are formed on the exterior of the stator. The grooves may extend from one end of the stator to the other. Like the housing grooves, the stator grooves may be longitudinal, circumferential, or helical. A plurality of groove types may be used. Stator grooves may be used in the same embodiment as housing grooves.

### BRIEF DESCRIPTION OF THE DRAWINGS

FIG. 1 is a schematic view of a pump assembly in accordance with an embodiment of the invention in a wellbore.

FIG. 2 is a sectional view of a motor housing of the motor in FIG. 1 with internal oil grooves.

FIG. 3 is a cross-sectional view of the motor housing from FIG. 2, taken along the line 3-3 of FIG. 2 to illustrate longitudinal grooves.

FIG. 4 is a cross-sectional view of an alternative embodiment of a motor housing having circumferential grooves.

FIG. 5 is a cross-sectional view of another alternative embodiment of a motor housing having longitudinal and helical grooves.

FIG. 6 is a sectional view of another alternative embodiment of a motor housing with internal longitudinal lubricant grooves and external ridges.

FIG. 7 is a cross-sectional view of the motor housing of FIG. 6, taken along the line 7-7 of FIG. 6.

FIG. 8 is a side-view of an embodiment of a stator having longitudinal lubricant grooves.

FIG. 9 is a side view of another embodiment of a stator having helical lubricant grooves.

FIG. 10 is a side view of another embodiment of a stator having circumferential lubricant grooves.

FIG. 11 is a sectional view of an embodiment of the pump assembly of FIG. 1, having dimples on the pump motor housing.

FIG. 12 is an orthogonal view of another embodiment of the shroud of FIG. 1, showing one half of a two-part clamshell shroud with fins.

FIG. 13 is a side view of an alternative embodiment of the pump of FIG. 1, having external oil circulation tubes.

### DETAILED DESCRIPTION

The present invention will now be described more fully hereinafter with reference to the accompanying drawings which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout, and the prime notation, if used, indicates similar elements in alternative embodiments.

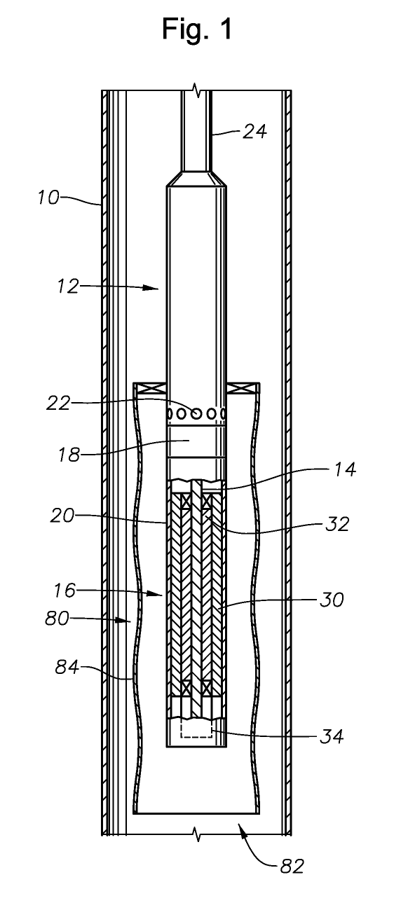

Referring to FIG. 1, wellbore casing 10 is shown in a vertical orientation, but it could be inclined. Pump 12 is suspended inside casing 10 and is used to pump wellbore fluid up from the well. Wellbore fluid may be any kind of fluid including, for example, crude oil, water, gas, liquids, other downhole fluids, or fluids such as water that may be injected into a rock formation for secondary recovery operations. Indeed, wellbore fluid can include desired fluids produced from a well or by-product fluids that an operator desires to remove from a well. Pump 12 may be centrifugal or any other type of pump and may have an oil-water separator or a gas separator. Pump 12 is driven by a shaft 14, operably connected to a motor 16. Seal section 18 is mounted between the motor 16 and pump 12. The seal section reduces a pressure differential between lubricant in the motor and well fluid. Motor 16 comprises housing 20. Housing 20 can be a cylindrical housing, and typically encases the other components of motor 16. Preferably, the fluid produced by the well (“production fluid”) flows past motor 16, enters an intake 22 of pump 12, and is pumped up through tubing 24. Normally, motor 16 is located below the pump 12 in the wellbore. The production fluid may enter the pump 12 at a point above the motor 16, such that the fluid is drawn up, past the motor housing 20 of the motor 16, and into the pump inlet 22.

Stator 30 is stationarily mounted in housing 20. Stator 30 comprises a large number of stator disks (laminations) having slots through them which are interlaced with three-phase copper windings. Stator 30 has an axial passage that extends through it. The clearance between the outer diameter (“OD”) of stator 30 and inner diameter (“ID”) of the housing 20 may be quite small.

Rotor 32 is located within the stator 30 passage and is rotably mounted on a plurality of bearings, the bearings being located between the rotor and the stator. Rotor 32 is mounted to shaft 14. Motor 16 has at least one rotor 32 and, in some embodiments, may have a plurality of rotors 32. Each of the rotors 32 are mounted on bearings (not shown). Alternating current supplied to windings cause rotor 32 to rotate. Motor 16 may generate heat in a variety of ways. For example, friction caused by the rotation of rotor 32 can generate heat or electrical resistance in the windings of stator 30 and rotor 32 can generate heat. Indeed, a variety of electrical and mechanical components within motor 16 can generate heat. Lubricant within the motor 16 transfers heat from components of the motor 16 to motor housing 20. Heat is then transferred from motor housing 20 to the production fluid on the outside of motor housing 20.

The rate of heat transfer is determined by the equation Q=h(A)(T); where Q=rate of heat transfer, h=the heat transfer coefficient, A=surface area, and T=the difference in temperature. The rate of heat transfer between the motor housing 20 and the production fluid may be increased by increasing (T), the difference in temperature between the motor housing and the production fluid. The difference in temperature may be increased by increasing the rate of heat transfer from the heat generating components of the motor 16, such as the rotor 32 and stator 30, to motor housing 20.

Motor 16 uses a lubricant to lubricate the moving parts such as rotor 32 and the bearings upon which rotor 32 is mounted. The lubricant could be, for example, a dielectric oil. In addition to lubricating the parts, the lubricant conducts heat from rotor 32 and stator 30 to the motor housing 20. Motor 16 may be filled with lubricant, such that lubricant occupies any spaces within housing 20. Lubricant pump 34 may be located in the lower end of housing 20. Lubricant pump 34 pumps lubricant through motor 16.

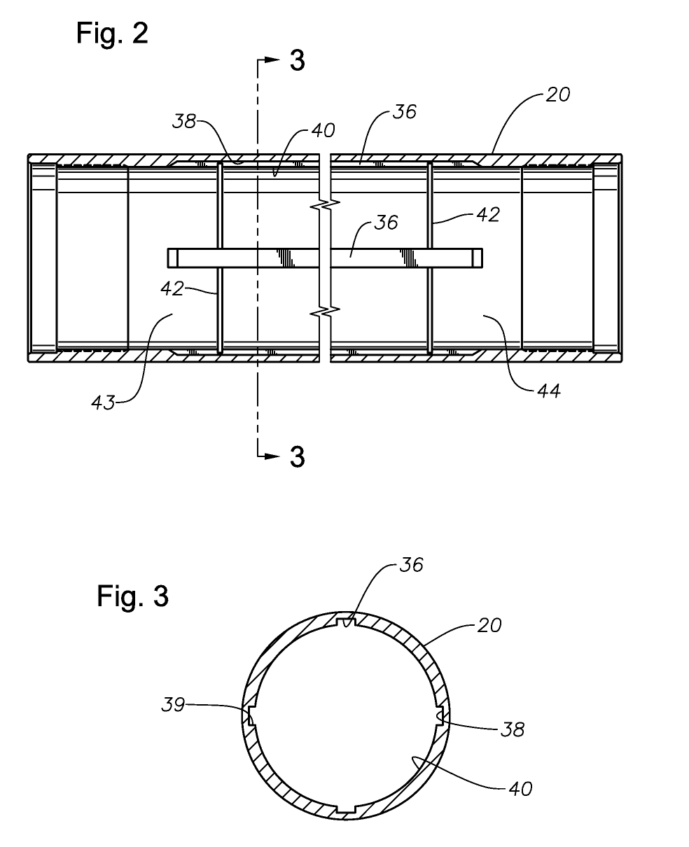

Referring to FIGS. 2 and 3, in one embodiment, one or more longitudinal grooves 36 are formed in the ID of motor housing 20 by, for example, stamping or milling grooves parallel to the axis of the motor housing 20. Longitudinal grooves 36 are parallel with the axis of housing 20. The distance from the recessed surface 38, which is the back of the grooved portion, to the axis of housing 20 is greater than the ID of the non-grooved portion 40. Snap ring grooves 42 indicate the location of the ends of the stator 30. The longitudinal grooves 36 intersect the circumferential snap ring grooves 42 and extend past the ends of the stator 30 so that oil may flow through the groove 36 from one end of the housing 20, past the stator 30 to the other end of the housing 20.

In one embodiment, lower reservoir 44 may be a void, filled with lubricant, located at one end of motor housing 20. Lubricant pump 34 (FIG. 1) may be located within lower end space 44. Upper reservoir 43 may be a void, filled with lubricant, located at the other end of motor housing 20. Reservoirs 44 and 43 are typically located beyond the axial length of stator 30. Lower reservoir 44 may be larger or smaller than upper reservoir 43. Some embodiments may have just one reservoir 44, or may have other voids, in different locations, that contain lubricant.

In one embodiment, longitudinal grooves 36 are in communication with lower lubricant reservoir 44 and upper lubricant reservoir 43. The number and spacing of longitudinal grooves 36 may vary. In the example there are four longitudinal grooves 36 equally spaced around the ID of housing 20.

Grooves 36 increase the surface area of the ID of the motor housing 20. The increased surface area increases the rate of heat transfer between the lubricant and the motor housing 20. A stator such as stator 30 in FIG. 1 closely fits within housing 20. Thus, a passage is defined by recessed surface 38, sidewalls 39 of groove 36, and an exterior surface of stator 30.

Grooves 36 thus provide a flow channel between stator 30 and housing 20, allowing lubricant to flow between the stator 30 and the housing, and thus flow in and out of reservoirs 43, 44. Lubricant pump 34 may cause the lubricant to flow through the passage associated with groove 36, thus transferring heat from hotter regions of motor 16 to cooler regions of motor 16. For example, heat can be transferred from stator 30 to housing 20. Furthermore, the lubricant can be located within the annular gap between stator 30 and housing 20, both within groove 36 and in the smaller gap outside of groove 36.

Furthermore, the irregular shape of the grooved ID on the motor housing 20 may create turbulence within the lubricant. The increased turbulence can increase the heat transfer coefficient (h) and thus increase the rate of heat transfer. In an exemplary embodiment (not shown), a series of longitudinal grooves is uniformly spaced around the circumference of the interior of the motor housing 20, each groove having the same depth, thus creating a profile that is corrugated in appearance. Alternatively, the depths of the grooves or the depth within a groove may vary.

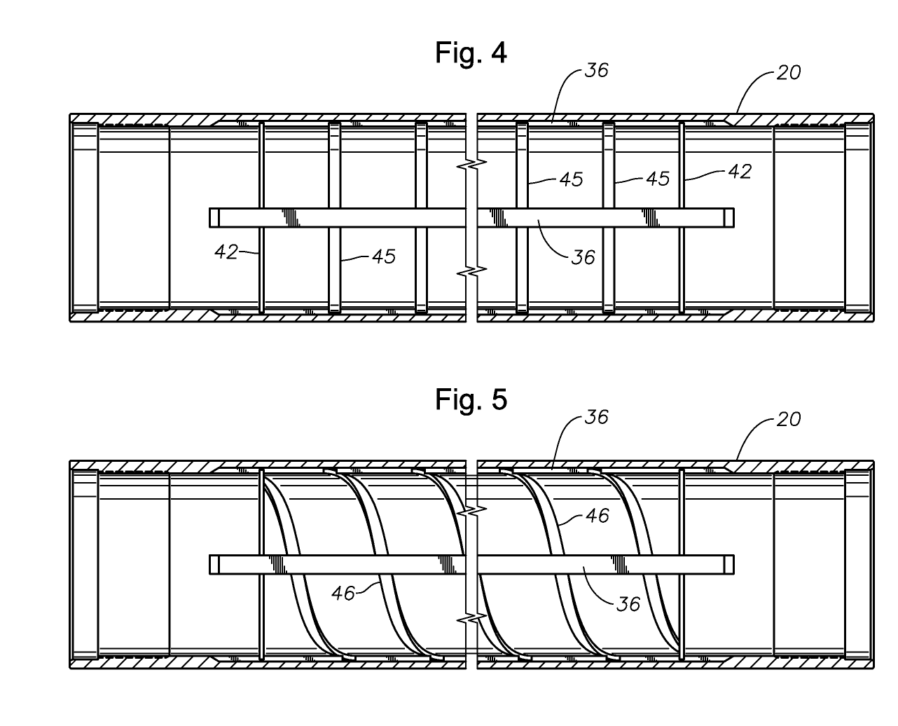

Referring to FIG. 4, in another embodiment, circumferential grooves 45 are formed around the circumference of the ID of the motor housing. The circumferential grooves 45 follow a line around the circumference of the motor housing 20, and may be used in combination with other grooves such as longitudinal grooves 36. Circumferential grooves 45 may be located between the upper and lower ends of the stator so that they are intersected by longitudinal grooves 36. The number and spacing of circumferential grooves 45 may vary.

Referring to FIG. 5, in this embodiment helical grooves 46 extend in helical fashion around the circumference along the length of the ID of the motor housing 20. The helical grooves 46 may be used with longitudinal grooves 36. Furthermore, a single embodiment could use grooves running in multiple directions, such that some could be longitudinal, some could be circumferential, and some could be at an angle in relation to the axis of the motor housing 20. Grooves such as circumferential grooves 45 and helical grooves 46 do not contain seals or snap rings; rather they comprise a void filled with lubricant.

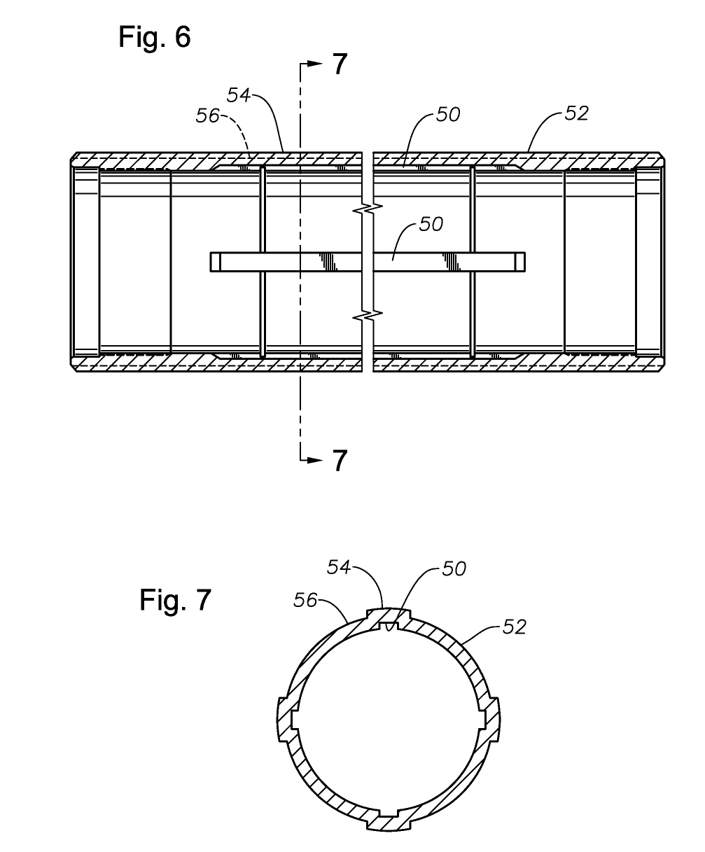

Referring to FIGS. 6 and 7, an internal groove 50 may also change the shape of the outer diameter (“OD”) of the motor housing 52. The result would be a raised surface or rib 54 on the OD, such that the OD of the raised surface 54 is greater than the OD 56 of other portions of the motor housing 52. Like the grooves 36 (FIGS. 2 and 3), the raised surface 54 may be longitudinal as shown, circumferential, helical, or a combination thereof. The raised surfaces 54 can be used to increase the surface area of the exterior of the motor housing 52, increase turbulence of the production fluid flowing past the housing, or both. The wall thickness of housing 52 radially outward from groove 50 may be substantially the same thickness as between grooves 50 due to raised surface 54.

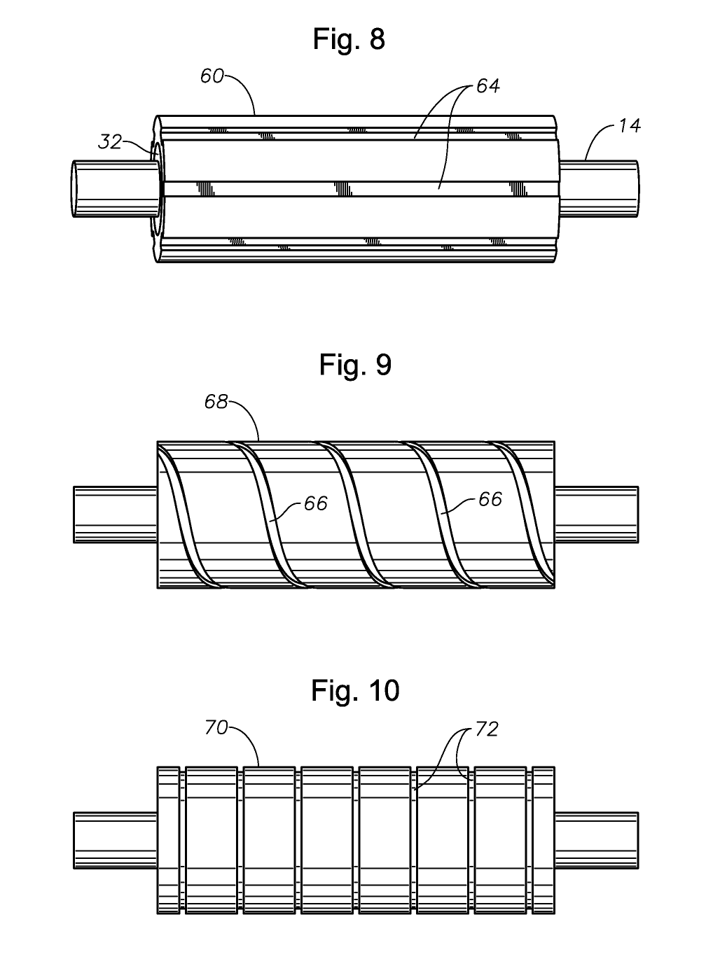

Referring to FIG. 8, a stator 60 is a cylindrical component inside motor housing 20 (FIG. 1). The outer diameter of the stator 60 is slightly smaller than the inner diameter of motor housing 20. Stator 60 is made up of a large number of thin, flat metal discs (laminations) with windings passing through aligned slots in the discs. Stator 60 extends substantially the length of the motor housing 20. The stator 60 defines a generally cylindrical outer diameter and central bore. The rotor 32 rotates inside the bore of fixed stator 60, spinning the motor shaft 14. In some embodiments, a plurality of rotors 32 rotate inside the bore of stator 60. Each rotor 32 is made of thin, metal discs also grouped in segments. Longitudinal grooves 64 may be formed in the OD of the stator 60. The groove or grooves 64 could be generally straight and extend from one end of the stator 60 to the other, parallel to the axis of stator 60. The depth of the grooves 64 may be shallow, such as less than ⅛″, or it may be deeper. The width of the grooves 64 may vary from less than ⅛″ to greater. Stator 60 could be located in a housing that has a cylindrical ID free of any oil grooves such as those shown in FIGS. 2-7. Alternatively, stator 60 could be located in one of the housings having grooves, as shown in FIGS. 2-7. Each groove 64 defines a passage bounded on three sides by the three surfaces of groove 64, and on the fourth side by in interior surface of housing 20.

Referring to FIG. 9, in this embodiment an internal helical groove 66 could extend about the cylindrical OD of stator 68 in helical fashion from one end to the other. Referring to FIG. 10, in this embodiment, the stator stack 70 may have circumferential grooves 72 on its OD that are circumferential about the OD of the stator 70 and may promote lateral lubricant flow. Any combination of longitudinal, circumferential, and helical grooves may be used.

Grooves in the OD of stator stack define passages between the stator and housing. The passages promote lateral and linear lubricant movement to transfer heat to the motor housing more effectively. The grooves may also increase turbulence in the lubricant, increase the surface area that is exposed to the lubricant, and increase the volume of lubricant between the stator and the motor housing.

An ESP motor comprising passages on the ID of the motor housing, OD of the stator, or both may be enhanced with other devices that increase the rate of heat transfer between the motor housing and the production fluid. A turbulator, for example, can be used to increase the turbulence of the wellbore fluid that is in contact with motor 16. Turbulators are fully described in U.S. patent application Ser. No. 12/416,808, which is incorporated herein by reference. In one embodiment, the turbulator, can comprise shroud 80 (FIG. 1). Passages on the ID of housing and/or the OD of the stator, for example, can increase the heat transfer from stator 30 to housing 20, and then a turbulator can increase the heat transfer from housing 20 to the wellbore fluid.

Referring to FIG. 1, the turbulator, shroud 80, can have an open lower end 82 and an upper end sealingly secured around pump 12 above intake 22. The shroud may be secured by other means and in other locations. The shroud 80 reduces the cross sectional area of the path of fluid flow and thus increases velocity. The higher velocity increases turbulence, which in turn increases the heat transfer coefficient (h) of the production fluid flow across the surface of the motor housing 20. The shroud 80 may have an irregular sidewall shape 84 to create pockets of turbulence between the shroud 80 and the motor housing 20. Furthermore, the motor housing 20 may have an irregular shape, such as dimples, to promote turbulence in the wellbore fluid as the wellbore fluid passes over the exterior of the motor housing.

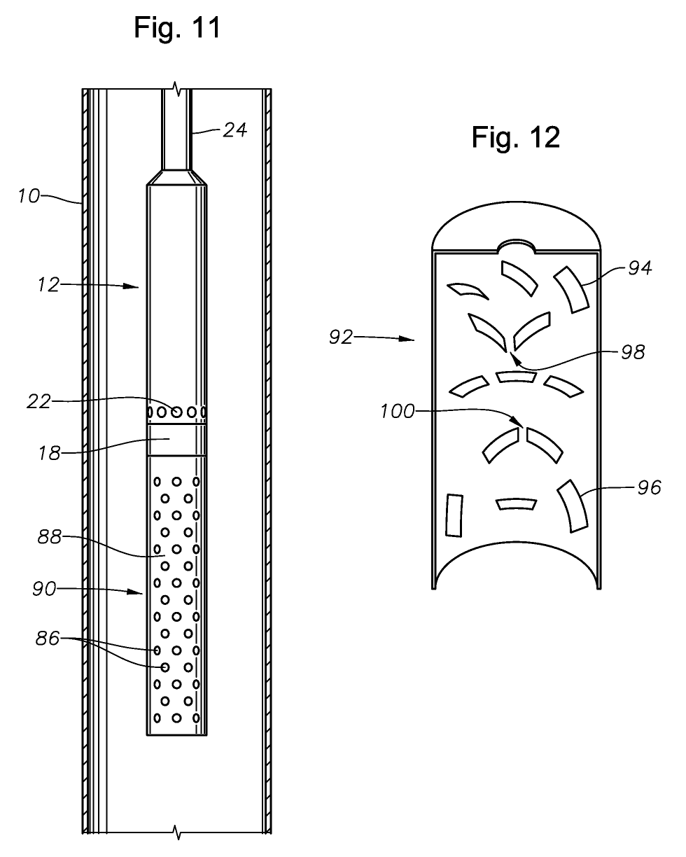

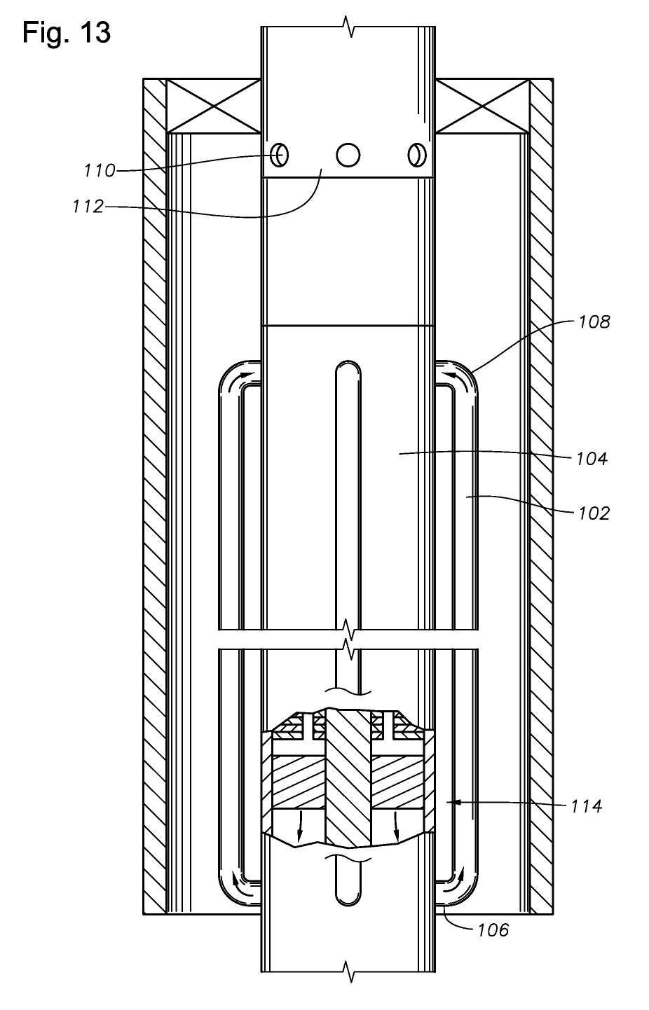

Referring to FIG. 11, the turbulator comprises multiple dimples 86 on motor housing 88 of motor 90. The dimples 86 are indentations or protrusions in the exterior surface of motor housing 88. The size of the indentations 86 may vary and could be, for example, made from a ¼″ or ½″ diameter round punch driven to a ⅛″ depth. Dimples 86 could also have a significantly larger or smaller diameter and be driven to a greater or lesser depth. Furthermore, the dimples 86 may have different shapes such as round, oval, square, and the like. The dimples 86 may be distributed about the surface in a symmetric pattern or they may be placed randomly. The dimples 86 may be concave or convex in relation to the exterior of the motor housing 88 and may be used regardless of whether a shroud is used. The dimples 86 increase the turbulence of the production fluid and thus increase the rate of heat transfer from the motor housing 88 to the production fluid. The dimples give the housing a textured surface. Other kinds of textured surfaces may also be used to increase turbulence. The dimples 86 may be used alone or in combination with other devices that increase production fluid turbulence.

Referring to FIG. 12, in one embodiment, shroud 92 is a clamshell configuration, wherein the shroud can be separated into two or more components. Fins 94 may be installed on motor housing 20 (FIG. 1) or shroud 92. A fin 94 could, for example, be welded to the shroud 92 and contact or nearly contact the motor housing 20 when the motor 16 is installed. This embodiment overcomes the inherent manufacturing and maintenance difficulties associated with attaching fins 94 directly to the motor housing 20, yet still creates turbulent flow immediately adjacent to the motor.

The fins 94 may be oriented in a variety of positions. In one embodiment, the fins 94 are attached at a 90 degree angle or normal in relation to the wall of the shroud 92. Fins 94 may be slanted in relation to the axis of the shroud 92, such as at a 45 degree angle. As illustrated by group 96 of fins 94, adjacent fins 94 may incline at the same inclination relative to the axis of shroud 92. Also, some of the adjacent fins 94 may slant at alternating angles to each other. For example, one fin 94 is slanted at a 45 degree angle in one direction, and the adjacent fin is slanted at an opposing 45 degree angle in the opposite direction, such that the bottom most edges 98 of the fins 94 are nearest each other and the fins diverge as they go up along the axis of the shroud. Other fins 94 may have the same 90 degree opposed orientation, but with the top most part 100 of the fins 94 nearest each other. The angle between opposed sets of fins 98 could be any angle. The fins 94 may be set at any variety of angles, and the fins need not be uniform in layout or in angles. In some embodiments, the fins join shroud 92 at an angle other than 90 degrees or normal relative to the surface of the shroud.

The various fin 94 configurations serve to disrupt the laminar flow of the production fluid as it flows past the motor housing 20 (FIG. 1) and shroud 92. In some embodiments, the flow develops swirling or vortexes. The fins 94 may be various lengths, including, for example, 1 to 3 inches long. The fins 94 may be attached to the clamshell shroud 92 by, for example, welding or adhesives before the halves of the clamshell 92 are joined.

Other techniques for increasing the rate of heat transfer from motor 16 to the wellbore fluid may also be used in conjunction with grooves on the ID of housing 20 and the OD of stator 30. For example, the motor lubricant may be circulated through external oil tubes. Apparatus and techniques for external oil circulation are illustrated in U.S. patent application Ser. No. 12/632,883, incorporated herein by reference.

Referring to FIG. 12, lubricant may circulate through circulation tubes 102 located on the exterior of pump motor 104. Each circulation tube 102 is a passage that is in fluid communication with interior portions of motor 104 in at least two locations. Circulation tubes 102 may attach to oil ports 106, 108 at any point on motor 104. Tubes 102 may, for example, attach to oil port 108 at the head of the motor 104, which is the end nearest the pump, and, for example, to oil port 106 at the base of motor 104. The circulation tubes 102 may connect to the oil ports 106, 108 by a variety of techniques, including, for example, pipe thread connections, welding, or quick disconnect fittings, and the like. Lubricant may circulate by, for example, entering each tube 102 at port 106, flowing up through tube 102, reentering motor 102 at port 108, and then passing through the interior of motor 102. When passing through motor 102, the lubricant may pass through, for example, grooves 36 located on the ID of housing 20 (FIG. 2) or grooves 64 on the OD of stator 60 (FIG. 8).

As the lubricant circulates through motor 104 and circulation tubes 102, the lubricant carries absorbed heat to circulation tubes 102. The exterior surfaces of circulation tubes 102 are submerged in and exposed to production fluid inside the wellbore. Thus heat is transferred from the circulating lubricant to circulation tubes 102 and then conducted through the surface of circulation tubes 102 and transferred to the production fluid. The production fluid carries the heat away as it is drawn past tubes 102, into intake 110 of pump 112, and subsequently pumped to the surface. Lubricant pump 114 may assist the flow of lubricant through motor 104 and circulation tubes 102. The lubricant may flow through circulation tubes 102 from the head towards the base, or from the base towards the head.

While the invention has been shown or described in only some of its forms, it should be apparent to those skilled in the art that it is not so limited, but is susceptible to various changes without departing from the scope of the invention.

I claim:

1. An apparatus for pumping fluid from a well, comprising:
a pump assembly;
a motor operably connected to the pump, the motor comprising
a lubricant reservoir containing a lubricant,
a motor housing having a cylindrical interior surface and an exterior,
a stator stationarily within the motor housing, the stator having a cylindrical outer surface and an axial passage therethrough,
one or more grooves located on one of the cylindrical surfaces, defining a lubricant passage for flow of the lubricant between the outer surface of the stator and interior surface of the housing; and
a rotor rotably mounted within the axial passage of the stator.

2. The apparatus according to claim 1, wherein at least one of the one or more grooves is parallel with an axis of the motor.

3. The apparatus according to claim 1, wherein at least one of the one or more grooves extends helically relative to an axis of the motor.

4. The apparatus according to claim 1, wherein at least one of the one or more grooves extends circumferentially around an axis of the motor.

5. The apparatus according to claim 1, wherein at least one of the one or more grooves is located on the interior cylindrical surface of the housing.

6. The apparatus according to claim 5, further comprising a raised rib on the exterior of the housing in registry with at least one of the one or more grooves.

7. The apparatus according to claim 1, wherein at least one of the one or more grooves is located on the outer surface of the stator.

8. The apparatus according to claim 1, wherein at least one of the one or more grooves is located on the interior cylindrical surface of the housing and wherein at least another one of the grooves is located on the outer surface of the stator.

9. The apparatus according to claim 1, wherein at least one of the one or more grooves is located in the interior surface of the housing and extends for an axial length at least equal to a length of the stator.

10. An apparatus for pumping fluid from a well, comprising:
a pump assembly;
a motor operably connected to the pump, the motor comprising
a lubricant reservoir containing a lubricant,
a motor housing having a cylindrical interior surface and an exterior,
a stator stationarily within the motor housing, the stator having a cylindrical outer surface and an axial passage therethrough,
a plurality of grooves located on one of the cylindrical surfaces, at least one of the grooves being parallel with an axis of the motor and extending at least from a first end of the stator to a second end of the stator to communicate lubricant from axially past the first end to axially past the second end of the stator; and
a rotor rotably mounted within the axial passage of the stator.

11. The apparatus according to claim 10, wherein at least one of the grooves extends helically relative to an axis of the motor.

12. The apparatus according to claim 10, wherein at least one of the grooves extends circumferentially around an axis of the motor.

13. The apparatus according to claim 10, wherein at least one of the grooves is located on the interior cylindrical surface of the housing.

14. The apparatus according to claim 13, further comprising a raised rib on the exterior of the housing in registry at least one of the grooves.

15. The apparatus according to claim 10, wherein at least one of the grooves is located on the outer surface of the stator.

16. The apparatus according to claim 10, wherein at least one of the grooves is located on the interior cylindrical surface of the housing and wherein at least another one of the grooves is located on the outer surface of the stator.

17. A method for increasing heat transfer from a submersible well pump motor to a well fluid comprising:
(a) operably connecting the motor to a pump, the motor having a housing and a stator located within the housing, the stator having an outer cylindrical surface closely spaced to an interior cylindrical surface of the housing;
(b) forming a groove in one of the cylindrical surfaces;
(c) operating the motor;
(d) flowing a motor lubricant through the groove; and
(e) transferring heat through the lubricant located in the groove between the housing and the stator.

18. The method of claim 17, wherein the groove is on the outer cylindrical surface of the stator.

19. The method of claim 17, further comprising flowing the lubricant from one end of the stator to an opposite end of the stator.

20. The method of claim 17, wherein the groove is on the interior cylindrical surface of the housing.
